(19) United States
(12) Patent Application Publication
(10) Pub. No.: US 2025/0058845 A1
(43) Pub. Date: Feb. 20, 2025

(54) ELECTRIC MOTORCYCLE

(71) Applicant: Greenworks (Jiangsu) Co., Ltd., Changzhou (CN)

(72) Inventors: Peng Gao, Changzhou (CN); Haiming Wang, Changzhou (CN); Guohui Wang, Changzhou (CN); Qi Gong, Changzhou (CN)

(21) Appl. No.: 18/804,205

(22) Filed: Aug. 14, 2024

(30) Foreign Application Priority Data
Aug. 14, 2023 (CN) 202322182161.4

(51) Int. Cl. B62J 43/16; B62J 43/28

(52) U.S. Cl. CPC B62J 43/16; B62J 43/28

(57) ABSTRACT

An electric motorcycle includes a frame assembly, a front wheel assembly, a rear wheel assembly and a battery compartment assembly. The frame assembly includes a casing and a seat assembled on the casing. The front wheel assembly is fixed on a first end of the frame assembly. The rear wheel assembly is fixed on a second end of the frame assembly. The battery compartment assembly is fixed on the casing and includes a battery pack and a compartment body to house the battery pack. The compartment body is integrally arranged with the casing. The battery pack is insertable and mounted in the compartment body. The casing is provided with a first receiving portion and a second receiving portion. A bottom of the seat is correspondingly provided with a first locking portion and a second locking portion to be clamped with the first receiving portion and second receiving portion.

### CROSS REFERENCE TO RELATED APPLICATION

The present application claims the priority of the following Chinese patent application: Ser. No. 20/232,2182161.4, filed on Aug. 14, 2023; the disclosure of which is hereby incorporated by reference herein in its entirety for all purposes.

### TECHNICAL FIELD

The disclosure relates to an electric motorcycle.

### BACKGROUND

As people pay more and more attention to environmental protection, it has become a general trend for vehicles to replace thermal power drive with chemical discharge drive. However, the battery and the frame of the conventional electric motorcycle are usually integrated with each other and the battery is generally fixed together with the frame, so it is difficult for the user to remove the battery from the frame. Therefore, when an electric motorcycle is parked outdoors, charging is extremely inconvenient. Users need to use a power strip to charge the electric motorcycle, while users living on higher floors find it difficult to charge the electric motorcycle parked on the ground in the community.

In addition, since the battery and the frame of the electric motorcycle are integrated, it is difficult for users to replace the battery for the electric motorcycle on their own when the battery ages.

In view of the above problems, it is necessary to provide an electric motorcycle to solve the above problems.

### SUMMARY

The disclosure provides an electric motorcycle. The electric motorcycle is provided with a compartment body integrally formed on the casing, so that a battery pack may be mounted in the compartment body by plugging and unplugging, and the user may easily mount, disassemble and replace the battery pack.

The disclosure provides the electric motorcycle, and the electric motorcycle includes a frame assembly, a front wheel assembly, a rear wheel assembly and a battery compartment assembly.

The frame assembly includes a casing and a seat assembled on the casing.

The front wheel assembly is mounted on a first end of the frame assembly.

The rear wheel assembly is mounted on a second end of the frame assembly.

The battery compartment assembly is fixed on the casing and includes a battery pack and a compartment body to house the battery pack, the compartment body integrally provided with the casing, and the battery pack is pluggable into the compartment body.

Wherein, the casing is provided with a first receiving portion and a second receiving portion, a bottom of the seat is provided with a first locking portion and a second locking portion, when the seat is assembled to the casing, the first receiving portion is clamped with the first locking portion, and the second receiving portion is clamped with the second locking portion.

In an embodiment of the disclosure, the compartment body, the first receiving portion and the second receiving portion are arranged in sequence in a driving direction of the electric motorcycle, the compartment body is arranged close to the front wheel assembly, and the second receiving portion is arranged close to the rear wheel assembly.

In an embodiment of the disclosure, the first receiving portion includes a locking groove arranged on the casing, the first locking portion is a protruding block protruding downward from the bottom of the seat, the protruding block includes a connecting part connected with the scat and an extending part extending outward from the connecting part, and a spacing is provided between the extending part and a bottom surface of the seat for the extending part being inserted into a bottom portion of the casing after the protruding block passes through the locking groove.

In an embodiment of the disclosure, an end of the extending part is recessed to provide a groove, the first receiving portion further includes a first limiting part provided on a bottom of the casing and a clamping block arranged on a side wall of the first limiting part, and when the extending part is inserted underneath the casing, the clamping block is limited and housed in the groove.

In an embodiment of the disclosure, an extending direction of the extending part is the same as a driving direction of the electric motorcycle, the first limiting part is arranged in a rectangular shape and defines a limiting cavity communicated with the locking groove, and the clamping block is located in the limiting cavity.

In an embodiment of the disclosure, the second receiving portion includes a inserting groove opened on the casing and a positioning part arranged at an end of the inserting groove, a bottom of the positioning part is provided with a positioning cavity and a separating board separating the positioning cavity from the inserting groove, and the second locking portion is configured to pass through the inserting groove and be buckled with the separating board so as to fasten the seat to the casing.

In an embodiment of the disclosure, the second locking portion includes a rotating shaft arranged at the bottom of the seat and a hook sleeved on the rotating shaft and rotatable relative to the rotating shaft, a clamping arm and a clamping groove located between the clamping arm and the rotating shaft are provided on the hook, and when the second locking portion is buckled with the separating board, the clamping arm is housed in the positioning cavity, and the separating board is housed in the clamping groove.

In an embodiment of the disclosure, the electric motorcycle further includes a driving controller. The driving controller is arranged in the casing to control a power on or a power off of the battery pack, a pin electrically connected with the driving controller is arranged at a bottom of the compartment body, and when the battery pack is inserted into the compartment body, the battery pack is electrically connected with the pin.

In an embodiment of the disclosure, a sliding bar is arranged on an inner side wall of the compartment body, a sliding groove is arranged on an outer side wall of the battery pack, and when the battery pack is inserted into the compartment body, the sliding bar is housed in the sliding groove and is slidable along the sliding groove.

In an embodiment of the disclosure, a buffer assembly matched with the battery pack is arranged at a bottom of the compartment body, the buffer assembly includes a bearing part and an elastic element located between the bearing part and the compartment body, and the bearing part is configured to bear the battery pack.

Beneficial effects of one or more embodiments of the disclosure are: the electric motorcycle is provided with the compartment body integrally formed on the casing, and at the same time the seat is detachably assembled with the casing, so that the battery pack may be mounted in the compartment body by plugging and unplugging after taking out the seat, and the user may easily mount, disassemble and replace the battery pack.

### BRIEF DESCRIPTION OF THE DRAWINGS

FIG. 1 is a perspective schematic view of an electric motorcycle according to an embodiment of the disclosure.

FIG. 2 is a perspective schematic view of the electric motorcycle in FIG. 1 from another angle.

FIG. 3 is an exploded view of the electric motorcycle in FIG. 1.

FIG. 4 is an exploded view of a seat and a casing in FIG. 3.

FIG. 5 is a schematic view of FIG. 4 from another angle.

FIG. 6 is a partial enlarged view of a first receiving portion in FIG. 5.

FIG. 7 is a partial enlarged view of a second receiving portion in FIG. 5.

FIG. 8 is a schematic view of FIG. 5 from another angle.

FIG. 9 is an exploded view of a battery pack and the casing in FIG. 3.

FIG. 10 is an exploded view of the casing in FIG. 9.

FIG. 11 is a perspective schematic view of a limiting assembly in FIG. 10.

### DETAILED DESCRIPTION

In order to enable a purpose, technical solutions and advantages of the disclosure to be clearer, the disclosure is described in detail below with reference to accompanying drawings and specific embodiments.

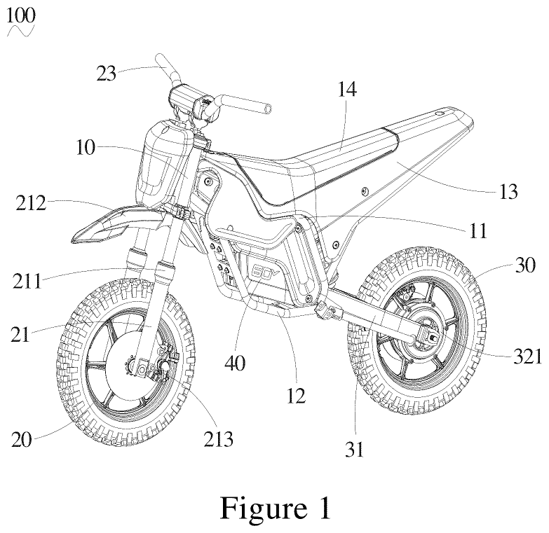

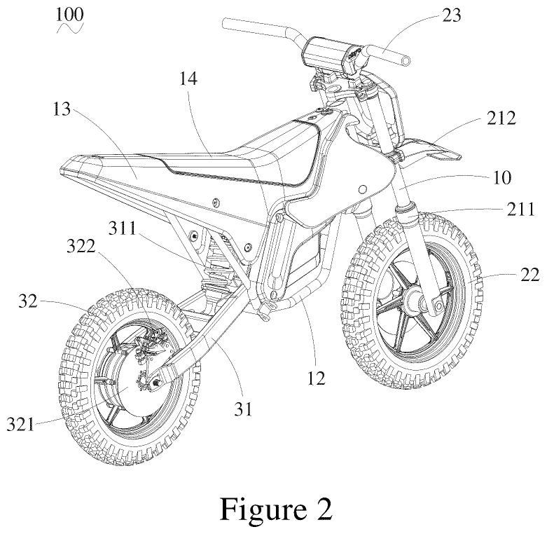

Please refer to FIG. 1 through FIG. 3. One or more embodiments of the disclosure provide an electric motorcycle 100, which includes a frame assembly 10, a front wheel assembly 20, a rear wheel assembly 30 and a battery compartment assembly 40. The front wheel assembly 20 is fixed and mounted on a first end of the frame assembly 10, and the rear wheel assembly 30 is fixed and mounted on a second end of the frame assembly 10. The battery compartment assembly 40 is fixed on the frame assembly 10 and includes a battery pack 41 and a compartment body 42 to house the battery pack 41, the compartment body 42 integrally arranged with the frame assembly 10, and the battery pack 41 is insertable and mounted in the compartment body 42.

The electric motorcycle 100 is provided with the compartment body 42 integrally formed with the frame assembly 10, so that the battery pack 41 may be mounted in the compartment body 42 by plugging and unplugging, and a user may easily mount, disassemble and replace the battery pack 41.

In an embodiment of the disclosure, the frame assembly 10 includes a cross frame 11, a curved frame 12, the casing 13 assembled on a top of the cross frame 11, and a seat 14 assembled on the casing 13. The battery compartment assembly 40 is vertically arranged between the cross frame 11 and the curved frame 12, and the compartment body 42 is integrally formed with the casing 13.

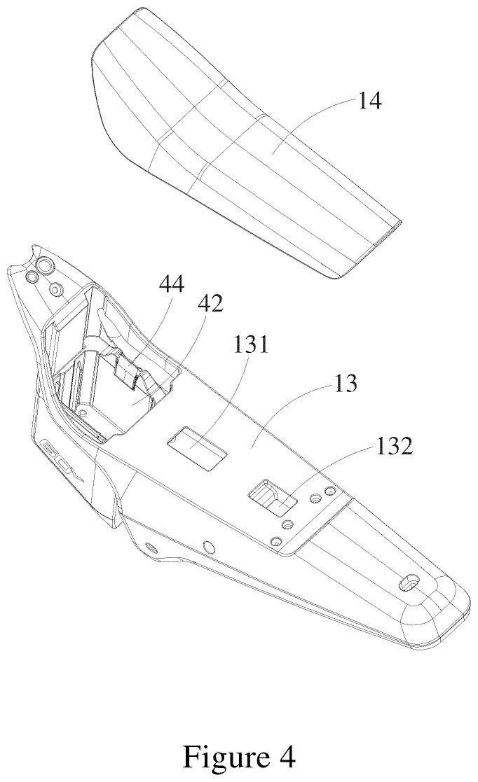

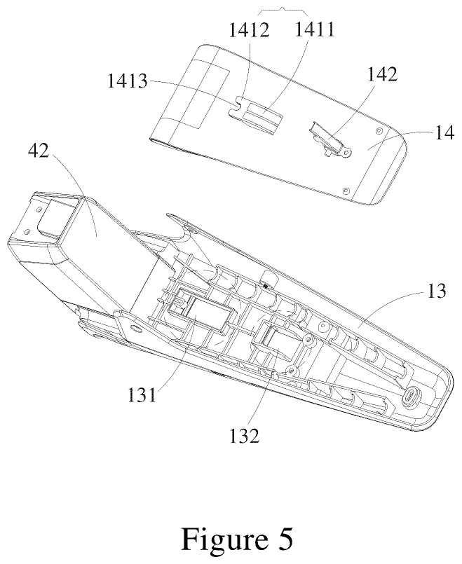

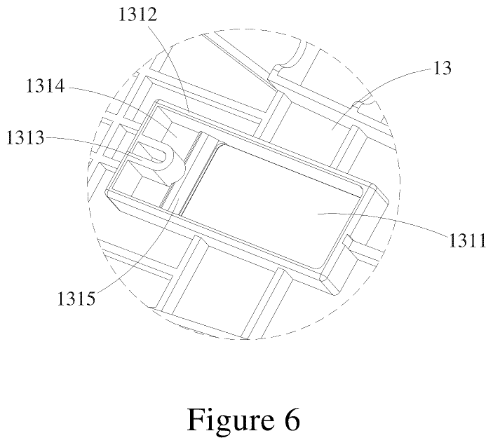

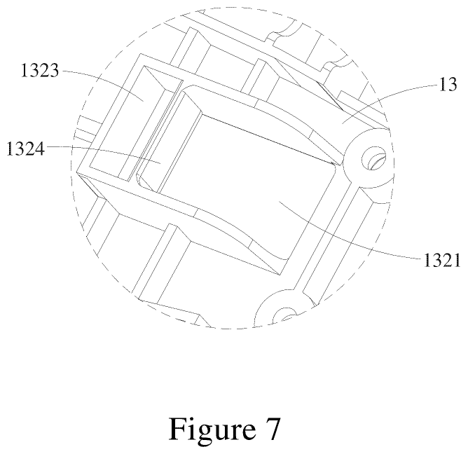

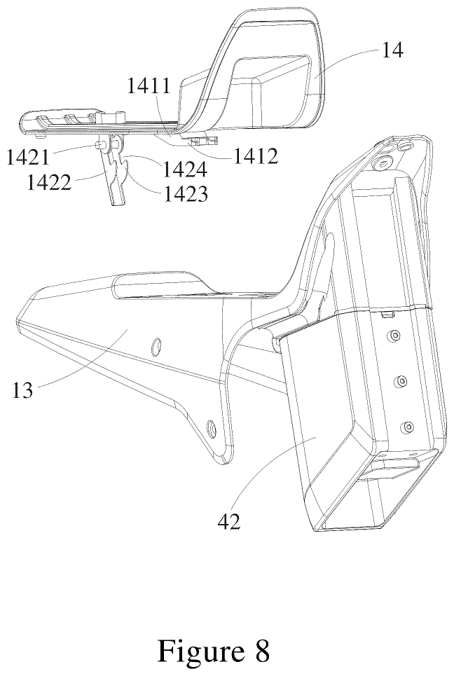

Please refer to FIG. 4 through FIG. 8. The casing 13 is provided with a first receiving portion 131 and a second receiving portion 132, a bottom of the seat 14 is correspondingly provided with a first locking portion 141 and a second locking portion 142. When the seat 14 is assembled and fixed to the casing 13, the first receiving portion 131 is clamped with the first locking portion 141, and the second receiving portion 132 is clamped with the second locking portion 142. In this way, the seat 14 and the casing 13 are detachably assembled and fixed with each other.

In an embodiment, the compartment body 42, the first receiving portion 131 and the second receiving portion 132 are arranged in sequence in a driving direction of the electric motorcycle 100, the compartment body 42 is arranged close to the front wheel assembly 20, and the second receiving portion 132 is arranged close to the rear wheel assembly 30.

The first receiving portion 131 includes a locking groove 1311 arranged on the casing 13, the first locking portion 141 is a protruding block protruding downward from the bottom of the seat 14, the protruding block 141 includes a connecting part 1411 connected with the seat 14 and an extending part 1412 extending outward from the connecting part 1411, and a spacing is provided between the extending part 1412 and a bottom surface of the seat 14 for the extending part 1412 being inserted into a bottom portion of the casing 13 after the protruding block 141 passes through the locking groove 1311 to enable the protruding block 141 to be buckled and connected with the casing 13.

An end of the extending part 1412 is recessed to provide a groove 1413, the first receiving portion 131 further includes a first limiting part 1312 provided on a bottom of the casing 13 and a clamping block 1313 arranged on a side wall of the first limiting part 1312, and when the extending part 1412 is inserted underneath the casing 13, the clamping block 1313 is limited and housed in the groove 1413. In some embodiments, an extending direction of the extending part 1412 is the same as the driving direction of the electric motorcycle 100, the first limiting part 1312 is arranged in a rectangular shape and defines a limiting cavity 1314 communicated with the locking groove 1311, and the clamping block is 1313 located in the limiting cavity 1314. The limiting cavity 1314 is further provided with a guiding part 1315 extending obliquely, which is used to guide the extending part 1412 to move toward the clamping block 1313 after the protruding block 141 is inserted into the locking groove 1311 until the clamping block 1313 is limitedly and housed in the groove 1413.

The second receiving portion 132 includes a inserting groove 1321 opened on the casing 13 and a positioning part 1322 arranged at an end of the inserting groove 1321, a bottom of the positioning part 1322 is provided with a positioning cavity 1323 and a separating board 1324 separating the positioning cavity 1323 from the inserting groove 1321, and the second locking portion 142 is configured to pass through the inserting groove 1321 and be buckled with the separating board 1324 so as to fasten the seat 14 to the casing 13. The second locking portion 142 includes a rotating shaft 1421 arranged at the bottom of the seat 14 and a hook 1422 sleeved on the rotating shaft 1421 and rotatable relative to the rotating shaft 1421, a clamping arm 1423 and a clamping groove 1424 located between the clamping arm 1423 and the rotating shaft 1421 are provided on the hook 1422, and when the second locking portion 142 is buckled with the separating board 1324, the clamping arm 1423 is housed in the positioning cavity 1323, and the separating board 1324 is housed in the clamping groove 1424.

The second locking portion 142 further includes a spring (not shown) elastically connecting the hook 1422 with the rotating shaft 1421. When the hook 1422 is pulled to disengage the clamping arm 1423 from the positioning cavity 1323, the spring is stretched, and after the hook 1422 is released, the hook 1422 can be reset under an action of the spring.

Therefore, when assembling the seat 14, the protruding block 141 first passes through the locking groove 1311 and the second locking portion 142 passes through the inserting groove 1321. Then the seat 14 is pushed toward a side of the front wheel assembly 20, so that the extending part 1412 is inserted underneath the casing 13 and the clamping block 1313 is limited and housed in the groove 1413. At the same time, the hook 1422 is pulled to enable the hook 1422 to rotate around the rotating shaft 1421 and enable the spring to be stretched. Finally, the hook 1422 is released, and the hook 1422 will be reset under the action of the spring until the clamping arm 1423 is housed in the positioning cavity 1323 and the separating board 1324 is housed in the clamping groove 1424. At this time, an assembly of the seat 14 is completed.

When removing the seat 14, the hook 1422 is first pulled to enable the hook 1422 to rotate around the rotating shaft 1421 until the clamping arm 1423 disengages from the positioning cavity 1323 and the separating board 1324 disengages from the clamping groove 1424. Then, the hook 1422 is pushed upward to enable the second locking portion 142 to disengage from the inserting groove 1321. Then, the seat 14 is pulled as a whole toward a side of the rear wheel assembly 30 to enable the clamping block 1313 to disengage from the groove 1413. Finally, the seat 14 is pulled as a whole upward to enable the protruding block 141 to disengage from the locking groove 1311 and enable the second locking portion 142 to disengage from the inserting groove 1321, so that the seat 14 is now disassembled. An entire mounting and disassembly process is very simple and convenient.

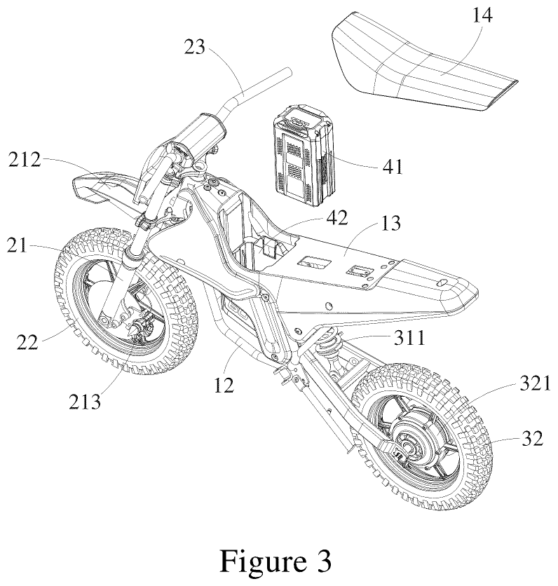

Please refer to FIG. 1 and FIG. 3. The front wheel assembly 20 includes a front fork 21, a front wheel 22 and a steering frame 23. The front fork 21 is fixedly mounted on the frame assembly 10, the front wheel 22 is fixedly mounted on the front fork 21, and the steering frame 23 is fixedly mounted on the front fork 21 to drive the front wheel 22 to steer. In some embodiments, the front fork 21 is provided with a front shock absorber 211, a front fender 212 and a front braking assembly 213. The front shock absorber 211 can play a buffer role, and the front braking assembly 213 can play a braking role.

The rear wheel assembly 30 includes a rear fork 31 mounted on the frame assembly 10 and a rear wheel 32 fixedly mounted on the rear fork 31. In some embodiments, the rear wheel 32 is provided with a hub motor 321 and a rear braking assembly 322, and the rear braking assembly 322 can play the braking role. Furthermore, the rear fork 31 is provided with a rear shock absorber 311 to play the buffer role.

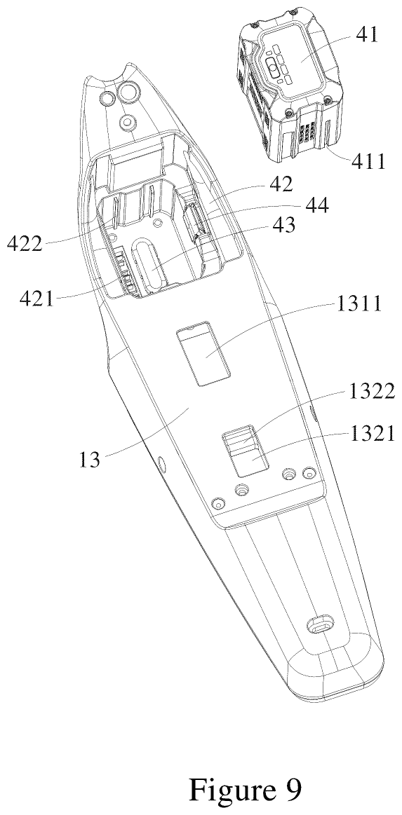

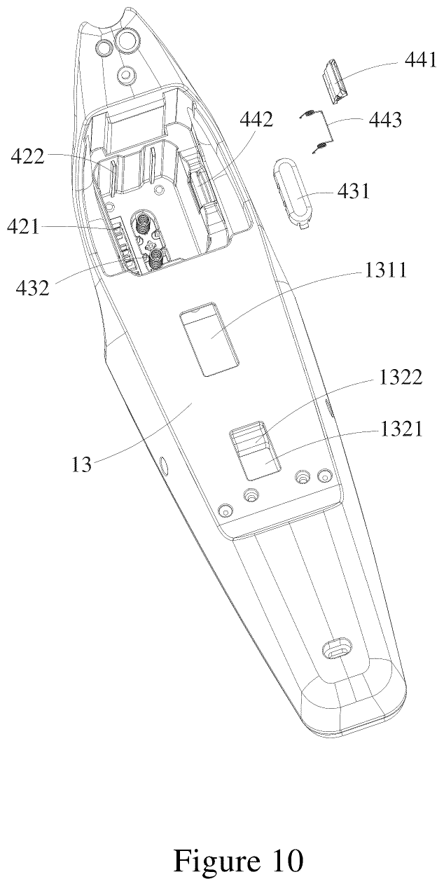

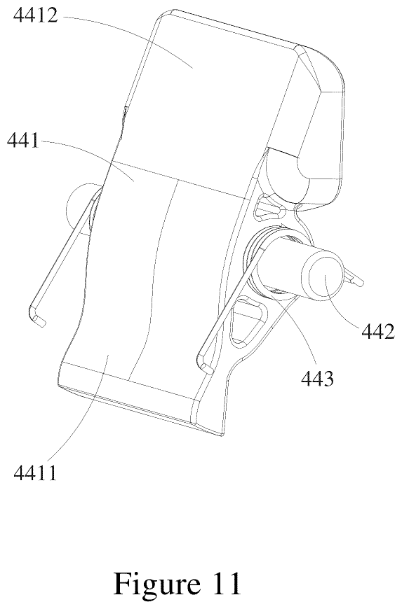

Please refer to FIG. 9 through FIG. 11. The electric motorcycle 100 further includes the driving controller (not labeled). The driving controller is fixed in the casing 13, arranged close to the compartment body 42, and used to control a power on and a power off of the battery pack 41 and a rotating speed of the hub motor 321. In an embodiment, a pin 421 electrically connected with the driving controller is arranged at a bottom of the compartment body 42, and when the battery pack 41 is inserted into the compartment body 42, the battery pack 41 is electrically connected with the pin 421.

A sliding bar 422 is arranged on an inner side wall of the compartment body 42, a sliding groove 411 is correspondingly arranged on an outer side wall of the battery pack 41, and when the battery pack 41 is inserted into the compartment body 42, the sliding bar 422 is housed in the sliding groove 41 and is slidable along the sliding groove 411. Such an arrangement enables it to be easy to accurately insert the battery pack 41 into the compartment body 42, and also enables it to be easy to remove the battery pack 41 from the compartment body 42.

A buffer assembly 42 matched with the battery pack 41 is arranged at a bottom of the compartment body 42, the buffer assembly 43 includes a bearing part 431 and an elastic element 432 located between the bearing part 431 and the compartment body 42, and the bearing part 431 is configured to bear the battery pack 41. When the battery pack 41 is placed in the compartment body 42, the elastic element 432 is elastically deformed under an action of the battery pack 41, thereby playing the buffering role.

A limiting assembly 44 is further arranged on the inner side wall of the compartment body 42 to limit the battery pack 41 in the compartment body 42 and prevent the battery pack 41 from shaking in the compartment body 42, thereby avoiding a poor contact between the battery pack 41 and the pin 421. The limiting assembly 44 includes a limiting plate 441 pivotally mounted on the inner side wall of the compartment body 42, a pivot 442 and an elastic component 443. The limiting plate 441 is pivotally mounted on the compartment body 42 through the pivot 442. The limiting plate 441 includes a supporting part 4411 located at a first end of the pivot 442 and a pressing part 4412 located at a second end of the pivot 442. A first end of the elastic component 443 abuts against the supporting part 4411, and a second end of the elastic component 443 abuts against the compartment body 42. When the battery pack 41 is placed in the compartment body 42, the battery pack 41 abuts against the supporting part 4411, which causes the elastic component 443 to deform elastically. When taking out the battery pack 41, the user presses the pressing part 4412 with a hand, and enables the elastic component 443 to continue to deform elastically. At this time, the supporting part 4411 is out of contact with the battery pack 41, and the user may take out the battery pack 41.

In summary, the electric motorcycle 100 of the disclosure is provided with the compartment body 42 integrally formed on the casing 13, and at the same time the seat 14 is detachably assembled with the casing 13, so that the battery pack 41 may be mounted in the compartment body 42 by plugging and unplugging after taking out the seat 14, and the user may easily mount, disassemble and replace the battery pack 41.

The above embodiments are only used to illustrate technical solutions of the disclosure rather than to limit it. Although the disclosure is described in detail with reference to the preferred embodiments, ordinary technicians in this field should understand that the technical solutions of the disclosure may be modified or replaced by equivalents without departing from a spirit and a scope of the technical solutions of the disclosure.

What is claimed is:

1. An electric motorcycle, comprising:
a frame assembly, comprising a casing and a seat assembled on the casing;
a front wheel assembly, mounted on a first end of the frame assembly;
a rear wheel assembly, mounted on a second end of the frame assembly; and
a battery compartment assembly, fixed on the casing and comprising a battery pack and a compartment body to house the battery pack, the compartment body integrally provided with the casing, and the battery pack being pluggable into the compartment body.

2. The electric motorcycle according to claim 1, wherein, the casing is provided with a first receiving portion and a second receiving portion, a bottom of the seat is provided with a first locking portion and a second locking portion, when the seat is assembled to the casing, the first receiving portion is clamped with the first locking portion, and the second receiving portion is clamped with the second locking portion.

3. The electric motorcycle according to claim 1, wherein, the compartment body, the first receiving portion and the second receiving portion are arranged in sequence in a driving direction of the electric motorcycle, the compartment body is arranged close to the front wheel assembly, and the second receiving portion is arranged close to the rear wheel assembly.

4. The electric motorcycle according to claim 1, wherein, the first receiving portion comprises a locking groove arranged on the casing, the first locking portion is a protruding block protruding downward from the bottom of the seat, the protruding block comprises a connecting part connected with the seat and an extending part extending outward from the connecting part, and a spacing is provided between the extending part and a bottom surface of the seat for the extending part being inserted into a bottom portion of the casing after the protruding block passes through the locking groove.

5. The electric motorcycle according to claim 4, wherein, an end of the extending part is recessed to provide a groove, the first receiving portion further comprises a first limiting part provided on a bottom of the casing and a clamping block arranged on a side wall of the first limiting part, and when the extending part is inserted underneath the casing, the clamping block is limited and housed in the groove.

6. The electric motorcycle according to claim 5, wherein, an extending direction of the extending part is the same as a driving direction of the electric motorcycle, the first limiting part is arranged in a rectangular shape and defines a limiting cavity communicated with the locking groove, and the clamping block is located in the limiting cavity.

7. The electric motorcycle according to claim 1, wherein, the second receiving portion comprises a inserting groove opened on the casing and a positioning part arranged at an end of the inserting groove, a bottom of the positioning part is provided with a positioning cavity and a separating board separating the positioning cavity from the inserting groove, and the second locking portion is configured to pass through the inserting groove and be buckled with the separating board so as to fasten the seat to the casing.

8. The electric motorcycle according to claim 7, wherein, the second locking portion comprises a rotating shaft arranged at the bottom of the seat and a hook sleeved on the rotating shaft and rotatable relative to the rotating shaft, a clamping arm and a clamping groove located between the clamping arm and the rotating shaft are provided on the hook, and when the second locking portion is buckled with the separating board, the clamping arm is housed in the positioning cavity, and the separating board is housed in the clamping groove.

9. The electric motorcycle according to claim 1, further comprising a driving controller, wherein, the driving controller is arranged in the casing to control a power on or a power off of the battery pack, a pin electrically connected with the driving controller is arranged at a bottom of the compartment body, and when the battery pack is inserted into the compartment body, the battery pack is electrically connected with the pin.

10. The electric motorcycle according to claim 1, wherein, a sliding bar is arranged on an inner side wall of the compartment body, a sliding groove is arranged on an outer side wall of the battery pack, and when the battery pack is inserted into the compartment body, the sliding bar is housed in the sliding groove and is slidable along the sliding groove.

11. The electric motorcycle according to claim 1, wherein, a buffer assembly matched with the battery pack is arranged at a bottom of the compartment body, the buffer assembly comprises a bearing part and an elastic element located between the bearing part and the compartment body, and the bearing part is configured to bear the battery pack.
